(19) United States
(12) Patent Application Publication
(10) Pub. No.: US 2005/0153066 A1
(43) Pub. Date: Jul. 14, 2005

(54) Method for manufacturing a surface optical layer

(76) Inventors: Wei-Duz Hong, Ping Chen City (TW); Tung-Lung Li, Ping Chen City (TW); Lung-Hai Wu, Ping Chen City (TW); Ta-Wang Lai, Ping Chen City (TW)

Correspondence Address: PRO-TECHTOR INTERNATIONAL SERVICES, 20775 Norada Court, Saratoga, CA, 95070-3018, US

(21) Appl. No.: 10/946,245

(22) Filed: Sep. 20, 2004

(30) Foreign Application Priority Data
Jan. 9, 2004 (TW) 93100613

(51) Int. Cl. B05D 5/06

(52) U.S. Cl. 427/162

(57) ABSTRACT

A transparent resin having a plurality of transparent particles is spread on an optical sheet. The transparent resin is exposed to ultraviolet light of a first power and then cured by ultraviolet light of a second power, which is greater than the first power. Thus, surface optical layers with different optical properties are easily obtained by only adjusting the power of ultraviolet light, without changing the original content of the surface optical layer or the parameters of its spreading process.

### BACKGROUND

1. Field of Invention

The present invention relates to a method for manufacturing an optical element of a display device. More particularly, the present invention relates to a method for manufacturing a surface optical layer.

2. Description of Related Art

Due to the internal light source of a transmissive display transmitting light outwardly, an anti-glare film is usually coated on the surface of the display to scatter the internal light to prevent the light from being shone too intensely and distractingly on the user. Additionally, if external light shines on the display surface and is reflected at the user without scattering, the user feels uncomfortable and has difficulty viewing the display. Therefore, the anti-glare film must be able to reduce the reflection of external light outside the display as well as scatter internal light originating from inside the display.

Many conventional techniques and patents discuss anti-glare film. For example, an anti-glare hard coat film is disclosed in U.S. Pat. No. 5,998,013. The anti-glare hard coat film comprises agglomerated colloidal silica particles, in which the surface texture created by the particles scatters the light. The prior art generally changes the lumpy surface texture of the anti-glare film, such as by increasing the diameter of the particles or adjusting the mixing density of the particles, to modify the scattering of external light, or the haze, definition, and glossiness of the film.

Once the diameter or the mixing density of the particles is changed, the parameters of the spreading process of the film, such as spreading speed, baking temperature and time, also need to be changed. Display manufacturers usually ask film manufacturers to change the specifications of the anti-glare film for optimization after the content and the spreading process parameters of the film are decided. Conventionally, when the content of the film is changed to meet the new specifications, the proper spreading process parameters for the new content are determined through trial and error to finally obtain the improved anti-glare film that satisfies the display manufacturer. Consequently, manufacturing finances are wasted, research and development efforts are consumed, preparation time for mass production is lengthened; manufacturing an anti-glare film in this way is uneconomical.

### SUMMARY

It is therefore an objective of the present invention to provide an anti-glare film, which is used in a display to scatter light, such that the visibility of the display is increased and the user does not feel uncomfortable while viewing the display.

It is another objective of the present invention to provide a method for manufacturing an anti-glare film, which only changes the steps of the exposing process, and does not change the original content and spreading process parameters, in order to enhance the optical properties of the anti-glare film and the flexibility of making modifications according to the requirements of the display manufacturers.

It is still another objective of the present invention to provide a method for manufacturing a surface optical layer, in which a simple process replaces the conventional complicated process, to reduce the manufacturing cost, researching and developing efforts, and the preparation time for mass production.

In accordance with the foregoing and other objectives of the present invention, a method for manufacturing a surface optical layer is provided. A transparent resin having a plurality of transparent particles is spread on an optical sheet. The transparent resin is exposed to ultraviolet (UV) light of a first power and then cured by ultraviolet light of a second power, which is greater than the first power. Thus, surface optical layers with different optical properties are easily obtained by only adjusting the power of ultraviolet light, without changing the original content of the surface optical layer or the parameters of the spreading process.

According to one preferred embodiment of the invention, the surface optical layer is an anti-glare film, an anti-reflection film or other optical film solidified by UV light. The optical sheet is baked after the transparent resin is spread thereon to remove the solvent in the transparent resin. The solvent is methyl benzene, isopropyl alcohol or other volatile material. The transparent resin comprises a light-cured resin and the transparent particles comprise silicon dioxide. The optical sheet is a polarizer, and the transparent resin is in contact with a triacetyl cellulose (TAC) layer of the polarizer. In this preferred embodiment, a wavelength of the UV light is less than 400 nm, a ratio of the second power to the first power is between about 500 and 3000, and the preferred ratio is between about 500 and 1000.

The invention illuminates the transparent resin with UV light of at least two different powers to expose and solidify the transparent resin, thereby replacing the complicated conventional process. Therefore, since the original content of the layer and the parameters of its spreading process are maintained, the film manufacturers can easily change the optical properties of the surface optical layer by merely adjusting the power of the exposing UV light. Surface optical layers with different optical properties are easily obtained according to the different requirements of customers, thereby effectively improving the flexibility of the manufacturing. Furthermore, the manufacturing method of the invention is simple and easy to practice, and therefore, the invention can substantially reduce the manufacturing cost, researching and developing efforts, and the preparation time for mass production.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a flow chart of one preferred embodiment of the invention; and

FIG. 2 illustrates a cross-sectional view of one preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention spreads a transparent resin having a plurality of transparent particles on an optical sheet, and exposes and solidifies the transparent resin by UV light of at least two different powers. When the transparent resin is exposed to UV light of a lower power, the transparent resin is not totally solidified. This step is critical to change the optical properties of the surface optical layer, in which when the exposing time of UV light of the lower power is longer, the resultant haze of the surface optical layer is higher while the transparency of the surface optical layer is kept intact.

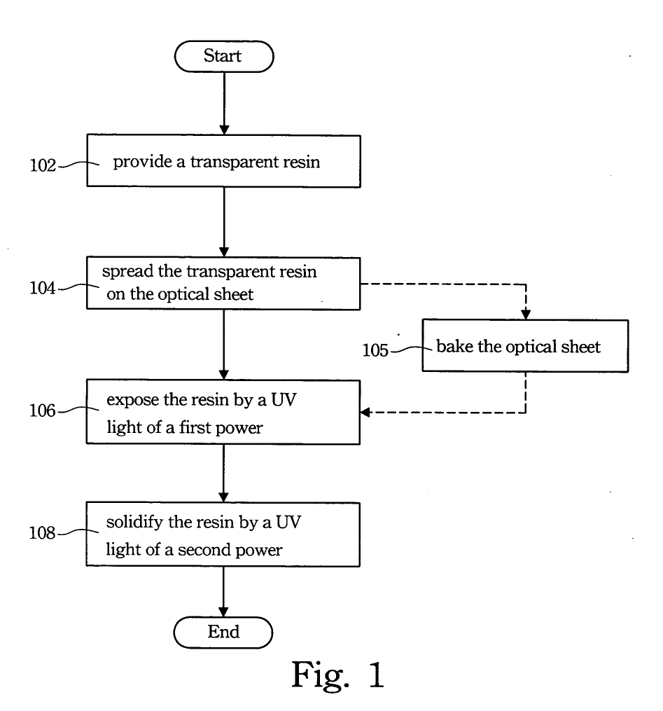

Referring to FIG. 1, a flow chart of one preferred embodiment of the invention is illustrated with respect to an anti-glare film. The manufacturing method of the invention provides a transparent resin, which has a plurality of transparent particles (step 102). The transparent resin is then spread on a surface of an optical sheet (step 104). Next, the transparent resin is exposed to UV light of a first power (step 106) and then solidified by exposure to UV light of a second power, which is greater than the first power (step 108). Additionally, in this preferred embodiment, after spreading the transparent resin on the optical sheet, the optical sheet can be baked to remove solvent, such as methyl benzene or isopropyl alcohol, contained in the transparent resin (step 105).

As described above, the embodiment changes the optical properties of the anti-glare film by merely adjusting the power of UV light, without changing the original content of the film or the parameters of its spreading process. According to experimental results of the preferred embodiment, a ratio of the second power to the first power is between about 500 and 3000, with a ratio between about 500 and 1000 being preferred.

In the preferred embodiment, the transparent resin comprises a light-cured resin, such as one cured by UV light. The transparent particles comprise silicon dioxide. The wavelength of the UV light is less than 400 nm. The first power is set to about 120 mW, and the second power is set to about 80 W, which is about 667 times the first power. Table 1 lists the experimental measurements of three optical properties, definition, haze and transparency, for the anti-glare films which are manufactured by a conventional exposing process and for films manufactured by exposing them to 120 mW UV light for 15, 30 and is 60 seconds, respectively, so as to compare the effects.

TABLE 1
A comparison of the optical properties of the conventional
exposing process to the two-step exposing process of the invention.

| Exposing conditions | Definition | Haze | Transparency |
|---|---|---|---|
| Conventional process | 148.3 | 32.79 | 91.33 |
| 120 mW UV light for 15 sec | 169.9 | 34.78 | 91.18 |
| 120 mW UV light for 30 sec | 146 | 39.66 | 91.13 |
| 120 mW UV light for 60 sec | 118.2 | 45.62 | 91.29 |

From Table 1, the optical properties, that is, the definition, haze and transparency, of the anti-glare films manufactured by the method of the embodiment are significantly changed by the lower power UV light. When the exposing time of the lower power UV light is longer, the resultant haze of the anti-glare film is greater, and the resultant definition of the anti-glare film is lower. However, the manufacturing of the embodiment does not affect the transparency of the anti-glare film, as illustrated in Table 1. In other words, the method can improve the haze of the anti-glare film without worsening the brightness and contrast, the most important factors for the performance of the display, and is therefore a more practical and less problematic invention.

The method adds a low power UV light exposing process prior to the conventional high power UV light exposing process in order to replace the time-consuming and effort-wasting prior art which necessitates changing the original content of the film and the parameters of the spreading process. Because the low power UV light can make the transparent particles slowly drift to the surface of the transparent resin, the surface roughness of the anti-glare film is therefore increased to enhance the haze thereof.

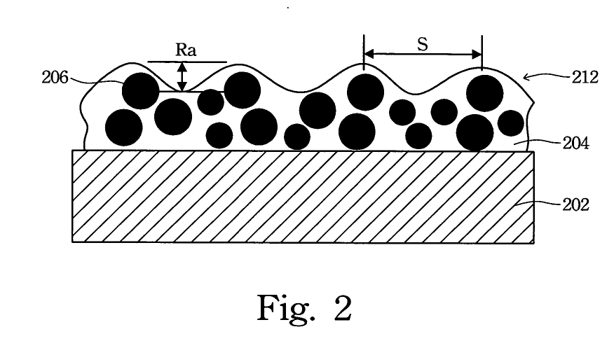

FIG. 2 illustrates a cross-sectional view of one preferred embodiment of the invention. A transparent resin 204 having a plurality of transparent particles 206 is spread on a surface of an optical sheet 202 to form an anti-glare film 212 for the optical sheet 202. The optical sheet 202 is a polarizer, of which a triacetyl cellulose (TAC) layer is in contact with the anti-glare film 212. The surface properties of the anti-glare film 212 can be mainly represented by two qualities, surface roughness (Ra) and mean spacing of local peaks of the profile (S). Table 2 lists the experimental data for the surface properties, Ra and S, of the anti-glare films which are manufactured by a conventional exposing process and of the films manufactured by exposure to 120 mW UV light for 15, 30 and 60 seconds, respectively, to compare how the method can change the surface structure of the anti-glare film.

TABLE 2
A comparison of the surface properties of the conventional
exposing process to the two-step exposing process of the invention.

| Exposing conditions | Ra (μm) | S (mm) |
|---|---|---|
| Conventional process | 0.19 | 0.049 |
| 120 mW UV light for 15 sec | 0.22 | 0.041 |
| 120 mW UV light for 30 sec | 0.26 | 0.034 |
| 120 mW UV light for 60 sec | 0.33 | 0.032 |

From Table 2, the surface properties, that is, the Ra and S, of the anti-glare films manufactured by the method of the embodiment are substantially changed by using the lower power UV light. When the exposing time of the lower power UV light is longer, the resultant Ra of the anti-glare film is higher and the resultant S of the anti-glare film is lower.

Besides the anti-glare film, the manufacturing of the invention can also be used to manufacture an anti-reflection film or other optical film that needs to be solidified by UV light. The method of the invention comprises two UV light exposing steps, exposing the transparent resin to the low power UV light and then solidifying the transparent resin by exposure to the high power UV light. However, other methods, such as the total exposing process, which has additional exposing steps using UV light of additional different powers or which exposes and solidifies the transparent resin by using different powers of UV light in sequential or non-sequential arrangement of powers, are all regarded as variations and applications of the present invention and fall within the scope of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for manufacturing a surface optical layer, the method comprising:
providing a transparent resin, wherein the transparent resin has a plurality of transparent particles;
spreading the transparent resin on an optical sheet;
exposing the transparent resin to a UV light of a first power; and
solidifying the transparent resin with a UV light of a second power, wherein the second power is greater than the first power.

2. The method of claim 1, wherein the transparent resin comprises a light-cured resin.

3. The method of claim 1, wherein the transparent particles comprise silicon dioxide.

4. The method of claim 1, wherein the optical sheet is a polarizer.

5. The method of claim 4, wherein the transparent resin is in contact with a triacetyl cellulose (TAC) layer of the polarizer.

6. The method of claim 1, wherein the method further comprises:
baking the optical sheet after spreading the transparent resin on the optical sheet.

7. The method of claim 1, wherein a ratio of the second power to the first power is between about 500 and 3000.

8. The method of claim 1, wherein a preferred ratio of the second power to the first power is between about 500 and 1000.

9. The method of claim 1, wherein a wavelength of the UV light is less than 400 nm.

10. A method for manufacturing a surface optical layer, the method comprising:
adding a plurality of transparent particles into a transparent resin;
spreading the transparent resin on an optical sheet;
shining the transparent resin with UV light of at least two different powers to expose and solidify the transparent resin.

11. The method of claim 10, wherein the transparent resin comprises a light-cured resin.

12. The method of claim 10, wherein the transparent particles comprise silicon dioxide.

13. The method of claim 10, wherein the optical sheet is a polarizer.

14. The method of claim 13, wherein the transparent resin is in contact with a triacetyl cellulose (TAC) layer of the polarizer.

15. The method of claim 10, wherein the method further comprises:
baking the optical sheet after spreading the transparent resin on the optical sheet.

16. The method of claim 10, wherein a ratio of a maximum to a minimum of the powers is between about 500 and 3000.

17. The method of claim 10, wherein a preferred ratio of a maximum to a minimum of the powers is between about 500 and 1000.

18. The method of claim 10, wherein a wavelength of the UV light is less than 400 nm.
